(19) United States
(12) Patent Application Publication
(10) Pub. No.: US 2003/0067232 A1
(43) Pub. Date: Apr. 10, 2003

(54) Methods and apparatus for securing an endshield to an electric motor

(76) Inventor: Scott Coonrod, Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/682,679

(22) Filed: Oct. 4, 2001

(51) Int. Cl. H02K 5/00

(52) U.S. Cl. 310/89

(57) ABSTRACT

An endshield assembly is described for an electric motor. The endshield assembly includes an endshield, at least one anchor, and a fastener. The endshield has a body, an inner face, and an outer face. The anchor extends radially outward from the endshield inner face and includes an end, a head, and an expandable shank extending therebetween. The shank has a wall and a bore. The bore extends between the end and the head. The wall defines the bore and extends convergently from the head to the end. The fastener is configured to expand the anchor wall to secure the endshield to the motor.

### BACKGROUND OF INVENTION

This invention relates generally to an endshield assembly for a motor and, more particularly to methods and apparatus for securing an endshield assembly to a motor.

At least some known motors include a motor housing, a stator, and a rotor assembly. The rotor assembly includes a rotor core and a rotor shaft extending through the core. The housing includes a shell and two endshields, and houses at least a portion of the rotor assembly. Motors also include at least one bearing sized to receive the rotor shaft. In some known motors, the endshields are coupled directly to the stator, which is formed from a stack of laminations. More specifically, the endshields are secured to the stator with keys, through-bolts, or a plurality of other similar fasteners.

Aligning the bearings with the rotor shaft such that the center of the bearing is substantially aligned with a centerline of the rotor shaft facilitates optimizing the operation of the motor. More specifically, bearing failures may be accelerated by a misalignment between the endshields supporting the bearings. In at least some known motors, the fasteners used to secure the endshields to the motor do not enable the endshields to be secured in a position on the motor once the bearings have been placed in proper alignment. Thus, such fasteners do not facilitate bearing alignment. Such fasteners, however, may increase a cost of assembly because of the number of fasteners that are attached and because such fasteners require a significant amount of time and skill to install.

### SUMMARY OF INVENTION

In one aspect, an endshield assembly for an electric motor is provided. The endshield assembly includes an endshield, at least one anchor, and a fastener. The endshield has a body, an inner face, and an outer face. The anchor extends radially outward from the endshield inner face and includes an end, a head, and an expandable shank extending therebetween. The shank has a wall and a bore. The bore extends between the end and the head. The wall defines the bore and extends convergently from the head to the end. The fastener is configured to expand the anchor wall to secure the endshield to the motor.

In another aspect, an electric motor assembly including a motor housing, a stator mounted in the motor housing and having a stack of laminations, a rotor core rotatably mounted in the motor housing, a rotor shaft extending through the rotor core, and at least one endshield assembly is provided. The stator has a first and second ends, and a bore extending therethrough. The rotor core extends through the stator bore. The endshield assembly includes an endshield, at least one anchor, and a fastener. The endshield has a body, an inner face facing the stack of laminations, and an outer face. The anchor extends from the endshield inner face towards the stack and includes an end, a head, and an expandable shank extending therebetween. The shank has a wall and a bore. The bore extends between the end and the head. The wall defines the bore and extends convergently from the head to the end. The fastener is configured to expand the anchor wall to secure the endshield to the motor.

In another aspect, a method for coupling an endshield assembly to an electric motor is provided. The method employs an endshield assembly having an endshield, at least one anchor, and a fastener. The endshield has a body, an inner face, and an outer face. The anchor extends radially outward from the endshield inner face and includes an end, a head, and an expandable shank extending therebetween. The shank has a wall and a bore. The bore extends between the end and the head. The wall defines the bore and extends convergently from the head to the end. The method includes the steps of providing the endshield assembly, positioning the endshield assembly in contact with the motor, and inserting a fastener configured to expand the anchor wall into the shank bore to secure the endshield to the motor.

### BRIEF DESCRIPTION OF DRAWINGS

FIG. 1 is a side elevational view of a motor.

FIG. 2 is a front elevational view of an outer face of an endshield assembly for the motor shown in FIG. 1.

FIG. 3 is a partial vertical cross-sectional view of the endshield assembly taken along line 2-2 shown in FIG. 2, and including an anchor and fastener used to secure an endshield to the motor.

FIG. 4 is a partial vertical cross-sectional view of the endshield assembly shown in FIG. 3 and secured to the motor by the anchor and fastener.

FIG. 5 is a partial vertical cross-sectional view of an endshield assembly including an alternative embodiment of an anchor.

FIG. 6 is a partial vertical cross-sectional view of the endshield assembly shown in FIG. 5 and secured to a motor by the alternative embodiment of the anchor.

FIG. 7 is a partial vertical cross-sectional view of an endshield assembly including a second alternative embodiment of an anchor.

### DETAILED DESCRIPTION

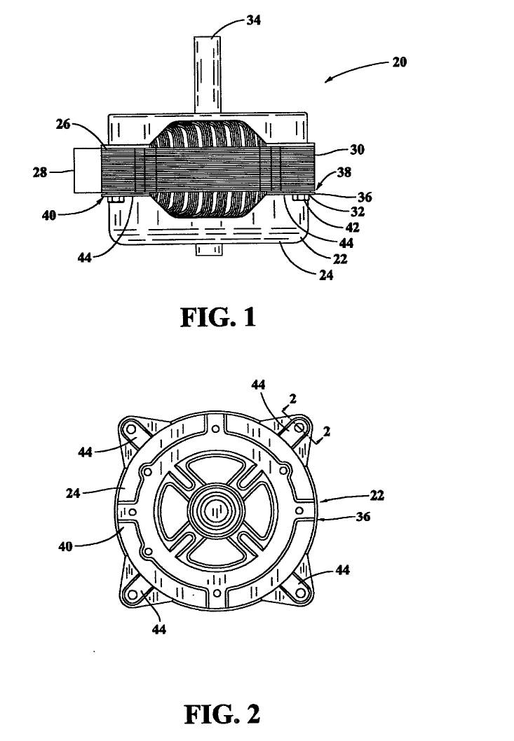

FIG. 1 is a side elevational view of a motor 20 showing endshield assembly 22 having endshield 24 secured on the end of a motor stator 26 made from a stack 28 of laminations 30. Stator 28 has a plurality of boreholes 32 therein for securing endshield 24 to stator 26. A bearing (not shown in FIG. 1) supports a rotatable shaft 34.

Endshield 24 has a body 36, an inner face 38 facing stack 28 of laminations 30 forming stator 28, and an outer face 40. A plurality of anchors 42 extend from inner face 38 towards stack 28. Anchors 42 are located on tabs 44 projecting from body 36 of endshield 24 and are in alignment with boreholes 32 on stator 28.

FIG. 2 is a front elevational view of endshield outer face 40. Endshield assembly 22 includes endshield 24 with tabs 44 projecting from body 36. Endshield 24 supports a bearing (not shown in FIG. 2).

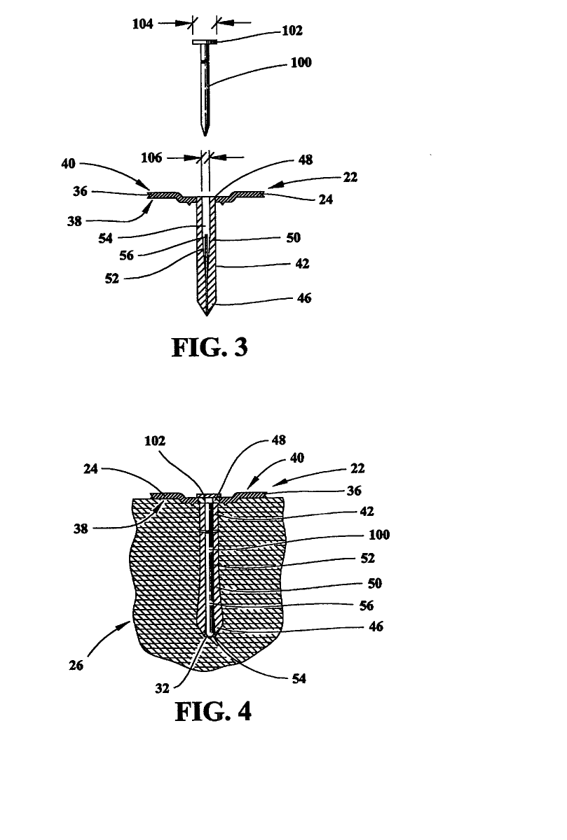

FIG. 3 is a partial vertical cross-sectional view of endshield assembly 22 taken along line 2-2 shown in FIG. 2 and including anchor 42 which facilitates securing endshield 24 to motor 20 (not shown in FIG. 3). Endshield assembly 22 includes anchor 42 extending from endshield inner face 38. Anchor 42 includes an end 46, a head 48, and an expandable shank 50 extending therebetween. Shank 50 has a wall 52, a bore 54, and a longitudinally divided section 56. Shank bore 54 extends between anchor end 46 and anchor head 48, and also through endshield body 36 to outer face 40. Wall 52 defines bore 54 and extends convergently from anchor head 48 to anchor end 46. Section 56 extends from anchor end 46 towards anchor head 48 and allows shank 50 to be expandable.

Fastener 100 is inserted into shank bore 54 and expands shank wall 52 such that endshield 24 is secured to motor 20. More specifically, fastener 100 is inserted into shank bore 54 after anchor 42 has been inserted into stator borehole 32 (not shown in FIG. 3) and expands shank wall 52 within stator borehole 32 such that endshield 24 is secured to stator 26 (not shown in FIG. 3).

In the exemplary embodiment, fastener 100 has a head 102 having a width 104 that is wider than a width 106 of shank bore 54 at anchor head 48. Accordingly, fastener head 102 contacts endshield outer face 40 when fastener 100 is fully inserted into shank bore 54. Fastener 100 is configured such that fastener head 102 contacts endshield outer face 40 when fastener 100 is inserted into shank bore 54 at a pre-determined depth, and thus, facilitates expanding anchor 42 a pre-determined amount. Fastener head 102 also facilitates the removal of fastener 100 such that endshield 24 can be unsecured from stator 26.

In one embodiment, anchor 42 is fabricated from a ductile metal. In an alternative embodiment, anchor 42 is fabricated from plastic. In another alternative embodiment, fastener 100 is fabricated from plastic.

FIG. 4 is a partial vertical cross-sectional view of endshield assembly 22 secured to motor 20 (not shown in FIG. 4) by anchor 42 and fastener 100. Endshield assembly 22 includes anchor 42 extending from endshield inner face 38 into corresponding stator borehole 32 to facilitate securing endshield 24 to stator 26. Anchor 42 includes end 46, head 48, and expandable shank 50 extending therebetween. Shank 50 has wall 52, bore 54, and longitudinally divided section 56. Shank bore 54 extends between anchor end 46 and anchor head 48, and also through endshield body 36 to outer face 40. Wall 52 defines bore 54 and extends convergently from anchor head 48 to anchor end 46. Section 56 extends from anchor end 46 towards anchor head 48. Fastener 100 is shown installed in anchor 42. Fastener 100 is configured to expand shank wall 52 to secure endshield 24 to stator 26.

During assembly, anchor 42 is inserted into corresponding stator borehole 32. Endshield 24 supporting a bearing (not shown in FIG. 4) is adjusted along stator borehole 32 until the bearing is in proper alignment with rotatable shaft 34 (not shown in FIG. 4). Once the bearing is aligned with rotatable shaft 34, fastener 100 is inserted into shank bore 54 until fastener head 102 is in contact with endshield outer face 40. Fastener 100 expands shank 50 along section 56 and secures endshield 24 to stator 26 with the bearing in proper alignment with rotatable shaft 34. Fastener 100 is configured such that fastener head 102 contacts endshield outer face 40 when fastener 100 is inserted into shank bore 54 at a pre-determined depth, and thus, facilitates expanding anchor 42 a pre-determined amount. Fastener head 102 also facilitates the removal of fastener 100 such that endshield 24 can be unsecured from stator 26.

FIG. 5 is a partial vertical cross-sectional view of an endshield assembly 200 including an alternative embodiment of an anchor 202. Endshield assembly 200 is substantially similar to endshield assembly 22, shown in FIGS. 3 and 4, and components in endshield assembly 200 that are identical to components of endshield assembly 22 are identified in FIG. 5 using the same reference numerals used in FIGS. 3 and 4. Accordingly, in this alternative embodiment, endshield assembly 200 includes anchor 202 extending from endshield inner face 38. Anchor 202 includes an end 204, a head 206, an expandable shank 208 extending therebetween, and an outer surface 210 having a plurality of teeth 212. Teeth 212 are configured to engage stator 26 (not shown in FIG. 5) within stator borehole 32 (not shown in FIG. 5). Shank 208 has a wall 214, a bore 216, and a longitudinally divided section 218. Shank bore 216 extends between anchor end 204 and anchor head 206, and also through endshield body 36 to outer face 40. Wall 214 defines bore 216 and extends convergently from anchor head 206 to anchor end 204. Section 218 extends from anchor end 204 towards anchor head 206 and allows shank 208 to be expandable.

Fastener 100 is inserted into shank bore 216 and expands shank wall 214 such that teeth 212 engage stator 26 within stator borehole 32 to secure endshield 24 to motor 20 (not shown in FIG. 5). More specifically, fastener 100 is inserted into shank bore 216 after anchor 202 has been inserted into stator borehole 32 and expands shank wall 214 such that teeth 212 engage stator 26 within stator borehole 32 to secure endshield 24 to stator 26.

In the exemplary embodiment, fastener 100 has head 102 having width 104 wider than a width 220 of shank bore 216 at anchor head 206. Accordingly, fastener head 102 contacts endshield outer face 40 when fastener 100 is fully inserted into shank bore 54. Fastener 100 is configured such that fastener head 102 contacts endshield outer face 40 when fastener 100 is inserted into shank bore 54 at a pre-determined depth, and thus, facilitates expanding anchor 42 a pre-determined amount. Fastener head 102 also facilitates the removal of fastener 100 such that endshield 24 can be unsecured from stator 26.

In one embodiment, anchor 202 is fabricated from a ductile metal. In an alternative embodiment, anchor 202 is fabricated from plastic. In another alternative embodiment, fastener 100 is fabricated from plastic.

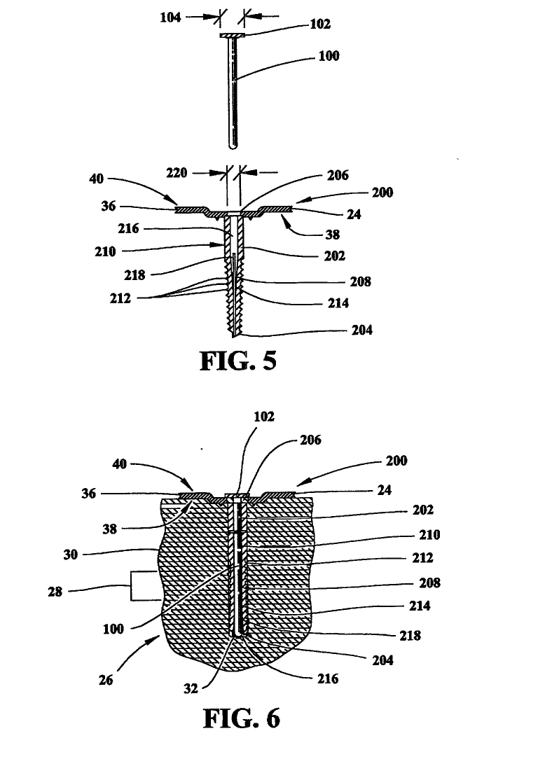

FIG. 6 is a partial vertical cross-sectional view of endshield assembly 200 secured to motor 20 (not shown in FIG. 6) by anchor 202 and fastener 100. Endshield assembly 200 includes anchor 202 extending from endshield inner face 38 into corresponding stator borehole 32 to facilitate securing endshield 24 to stator 26. Anchor 202 includes end 204, head 206, expandable shank 208 extending therebetween, and outer surface 210 with teeth 212. Teeth 212 are configured to engage stator 26 within stator borehole 32. Shank 208 has wall 214, bore 216, and longitudinally divided section 218. Shank bore 216 extends between anchor end 204 and anchor head 206, and also through endshield body 36 to outer face 40. Wall 214 defines bore 216 and extends convergently from anchor head 206 to anchor end 204. Section 218 extends from anchor end 204 towards anchor head 206 and allows shank 208 to be expandable. Fastener 100 is shown installed in anchor 202. Fastener 100 is configured to expand shank wall 214 to secure endshield 24 to stator 26.

During assembly, anchor 202 having teeth 212 is inserted into corresponding stator borehole 32. Endshield 24 supporting a bearing (not shown in FIG. 6) is adjusted along stator borehole 32 until the bearing is in proper alignment with rotatable shaft 34 (not shown in FIG. 6). Once the bearing is aligned with rotatable shaft 34, fastener 100 is inserted into shank bore 216 until fastener head 102 is in contact with endshield outer face 40. Fastener 100 expands shank 208 along section 218 engaging teeth 212 into laminations 30 of stack 28 which forms stator 26 and secures endshield 24 to stator 26 with the bearing in proper alignment with rotatable shaft 34. Fastener 100 is configured such that fastener head 102 contacts endshield outer face 40 when fastener 100 is inserted into shank bore 54 at a pre-determined depth, and thus, facilitates expanding anchor 42 a pre-determined amount. Fastener head 102 also facilitates the removal of fastener 100 such that endshield 24 can be unsecured from stator 26.

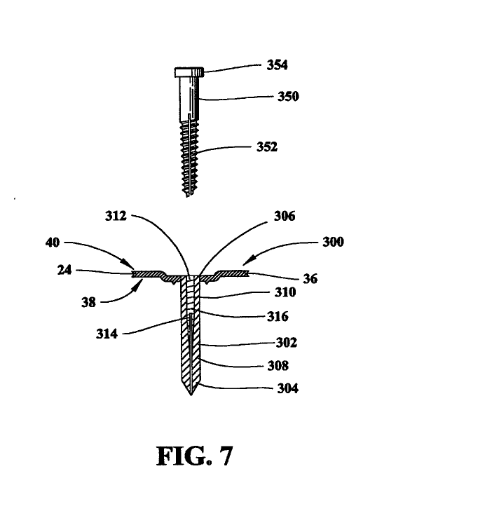

FIG. 7 is a partial vertical cross-sectional view of endshield assembly 300 including a second alternative embodiment of an anchor 302. Endshield assembly 300 is substantially similar to endshield assembly 22, shown in FIGS. 3 and 4, and components in endshield assembly 300 that are identical to components of endshield assembly 22 are identified in FIG. 7 using the same reference numerals used in FIGS. 3 and 4. Accordingly, in this second alternative embodiment, endshield assembly 300 has an anchor 302 extending from endshield inner face 38. Anchor 302 includes an end 304, a head 306, and an expandable shank 308 extending therebetween. Shank 308 has a wall 310, a bore 312, and a longitudinally divided section 314. Shank bore 312 extends between anchor end 304 and anchor head 306, and also through endshield body 36 to outer face 40. Shank bore 312 has a plurality of threads 316. Wall 310 defines bore 312 and extends convergently from anchor head 306 to anchor end 304. Section 314 extends from anchor end 304 towards anchor head 306 and allows shank 308 to be expandable.

Fastener 350 has a plurality of threads 352 configured to engage shank bore threads 316 such that when fastener 350 is screwed into shank bore 312 shank wall 310 expands to secure endshield 24 to motor 20 (not shown in FIG. 7). More specifically, fastener 350 is configured to be screwed into shank bore 312 after anchor 302 has been inserted into stator borehole 32 (not shown in FIG. 7) and expands shank wall 310 within stator borehole 32 securing endshield 24 to stator 26 (not shown in FIG. 7). Fastener threads 352 engage shank bore threads 316 to facilitate securing fastener 350 within shank bore 312.

During assembly, anchor 302 is inserted into corresponding stator borehole 32. Endshield 24 supporting a bearing (not shown in FIG. 7) is adjusted along stator borehole 32 until the bearing is in proper alignment with rotatable shaft 34 (not shown in FIG. 7). Once the bearing is aligned with rotatable shaft 34, fastener 350 with threads 352 is screwed into shank bore 312 with threads 316 until a fastener head 354 is in contact with endshield outer face 40. Fastener 350 expands shank 308 along section 314 and secures endshield 24 to stator 26 with the bearing in proper alignment with rotatable shaft 34. Fastener 350 is configured such that fastener head 354 contacts endshield outer face 40 when fastener 350 is screwed into shank bore 54 at a pre-determined depth, and thus, facilitates expanding anchor 42 a pre-determined amount. Fastener head 354 also facilitates the removal of fastener 350 such that endshield 24 can be unsecured from stator 26.

In one embodiment, anchor 302 is fabricated from a ductile metal. In an alternative embodiment, anchor 302 is fabricated from plastic. In another alternative embodiment, fastener 350 is fabricated from plastic.

In some known motors, the endshields support the motor bearings and are coupled directly to the stator. The endshields are usually secured to the stator with keys, through-bolts, or a plurality of other similar fasteners. These types of fasteners, however, facilitate an increase in the cost of assembly because of the number of fasteners that are attached and because such fasteners require a significant amount of time and skill to install. Furthermore, these types of fasteners do not facilitate securing the endshields and bearings in proper alignment with the rotor shaft. The present invention provides an endshield assembly that facilitates reducing the cost of assembly by using a reduced number of less expensive parts for securing an endshield to a stator, and by reducing assembly time and the requisite skill level of the assembly process. In addition, the present invention provides an endshield assembly that facilitates maintaining proper bearing alignment.

While the invention has been described in terms of various specific embodiments, those skilled in the art will recognize that the invention can be practiced with modification within the spirit and scope of the claims.

1. An endshield assembly for an electric motor, said endshield assembly comprising:
an endshield comprising a body, an inner face, and an outer face;
at least one anchor extending radially outward from said inner face, said anchor comprising an end, a head, and an expandable shank extending therebetween, said shank comprising a wall and a bore, said bore extending between said end and said head, said wall defining said bore and extending convergently from said head to said end; and
a fastener configured to expand said anchor wall to secure said endshield to the motor.

2. An endshield assembly in accordance with claim 1 wherein said anchor further comprises an outer surface comprising a plurality of teeth configured to engage the motor to secure said endshield to the motor.

3. An endshield assembly in accordance with claim 1 wherein said shank bore comprises a first width at said shank head and a second width at said shank end, said first width wider than said second width.

4. An endshield assembly in accordance with claim 3 wherein said fastener comprises a head having a width, said fastener head width wider than said shank bore first width.

5. An endshield assembly in accordance with claim 4 wherein said fastener comprises a plurality of threads, said shank bore comprises a plurality of threads, said fastener threads configured to engage said shank bore threads.

6. An endshield assembly in accordance with claim 1 wherein said anchor is fabricated from ductile metal.

7. An endshield assembly in accordance with claim 1 wherein said anchor is fabricated from plastic.

8. An electric motor assembly comprising:
a motor housing;
a stator comprising a stack of laminations, a first and second ends, and a bore therethrough, said stator mounted in said motor housing;
a rotor core rotatably mounted in said motor housing and extending through said stator bore;
a rotor shaft extending through said rotor core; and
at least one endshield assembly, each endshield assembly comprising an endshield comprising a body, an inner face facing said stack, and an outer face;
at least one anchor extending from said endshield inner face towards said stack, said anchor comprising an end, a head, and an expandable shank extending therebetween, said shank comprising a wall and a bore, said bore extending between said end and said head, said wall defining said bore and extending convergently from said head to said leading end; and
a fastener configured to expand said anchor wall to secure said endshield to the motor.

9. An electric motor assembly in accordance with claim 8 wherein said anchor further comprises an outer surface comprising a plurality of teeth configured to engage said motor to secure said endshield to said motor.

10. An electric motor assembly in accordance with claim 8 wherein said shank bore comprises a first width at said shank head and a second width at said shank end, said first width wider than said second width.

11. An electric motor assembly in accordance with claim 10 wherein said fastener comprises a head having a width, said fastener head width wider than said shank bore first width.

12. An electric motor assembly in accordance with claim 11 wherein said fastener and said shank bore are threaded, said fastener configured to couple to said shank bore.

13. An electric motor assembly in accordance with claim 8 wherein said stack comprises at least one borehole extending therein, said stack borehole positioned in alignment with said anchor and configured to receive said anchor such that said anchor engages said stack within said borehole to secure said endshield to the motor when said fastener engages said anchor wall.

14. An electric motor assembly in accordance with claim 8 wherein said anchor is fabricated from ductile metal.

15. An electric motor assembly in accordance with claim 8 wherein said anchor is fabricated from plastic.

16. A method of securing an endshield assembly to an electric motor, said method comprising:
providing an endshield assembly including an endshield having a body, an inner face, an outer face, and at least one anchor extending radially outward from the inner face, the anchor including an end, a head, and an expandable shank extending therebetween, the shank having a wall and a bore, the bore extending between the end and the head, the wall defining the bore and extending convergently from the head to the end;
positioning the endshield assembly in contact with the motor; and
inserting a fastener into the shank bore, the fastener configured to expand the anchor wall to secure the endshield to the motor.

17. A method in accordance with claim 16 wherein providing an endshield assembly further comprises providing an endshield assembly including the anchor having an outer surface having a plurality of teeth configured to engage the motor to secure the endshield to the motor.

18. A method in accordance with claim 16 wherein providing an endshield assembly further comprises providing an endshield assembly including a shank bore having a first width at the shank head and a second width at the shank end, the first width wider than the second width.

19. A method in accordance with claim 18 wherein providing an endshield assembly further comprises providing an endshield assembly including a fastener having a head with a width, the fastener head width wider than the shank bore first width.

20. A method in accordance with claim 19 wherein providing an endshield assembly further comprises providing an endshield assembly including the fastener having a plurality of threads, the shank bore having a plurality of threads, the fastener threads configured to engage the shank bore threads.

21. A method in accordance with claim 16 wherein positioning the endshield assembly comprises:
providing a stack of laminations forming a stator on the electric motor, the stator having at least one borehole extending into the stack, the borehole configured to receive the anchor; and
inserting the anchor into the stack borehole such that the anchor engages the stack within the borehole and secures the endshield to the motor.

22. A method in accordance with claim 16 wherein providing an endshield assembly further comprises providing an endshield assembly including an anchor fabricated from ductile metal.

23. A method in accordance with claim 16 wherein providing an endshield assembly further comprises providing an endshield assembly including an anchor fabricated from plastic.
